(19) United States
(12) Patent Application Publication
(10) Pub. No.: US 2008/0163867 A1
(43) Pub. Date: Jul. 10, 2008

(54) Molecular Separation Process in Various Steps of Process for Production of Chlorinated Sugars, Their Precursors and Derivatives

(76) Inventors: Subramanyam, Mumbai (IN); Rakesh Ratnam, Mumbai (IN); Sundeep Aurora, Mumbai (IN)

Correspondence Address: NATH & ASSOCIATES, 112 South West Street, Alexandria, VA, 22314, US

(21) Appl. No.: 11/884,679

(22) PCT Filed: Feb. 20, 2006
(86) PCT No.: PCT/IN2006/000058

§ 371 Date: Aug. 20, 2007

(30) Foreign Application Priority Data
Feb. 22, 2005 (IN) 198/MUM/2005

(51) Int. Cl. C13D 3/16

(52) U.S. Cl. 127/55

(57) ABSTRACT

This invention comprises novel application of a molecular separation process, including one or more of a membrane separation/filtration process comprising reverse osmosis, micro filtration, nanofiltration ultrafiltration and perevaporation and the like to several process streams obtained in process of production of for synthesis, purification or isolation of 1-6-Dichloro-1-6-DIDEOXY-β-Fructofuranosyl-4-chloro-4-deoxy-galactopyranoside (TGS), its precursors or its derivatives for achieving a separation of molecules in combination with conventional unit processes of separation.

### TECHNICAL FIELD

The present invention relates to a process wherein molecular separation processes are used in various steps of process for production for synthesis of chlorinated sucrose, 1-6-Dichloro-1-6-DIDEOXY-β-Fructofuranasyl-4-chloro-4-deoxy-galactopyranoside (TGS), their precursors and derivatives.

### BACKGROUND OF THE INVENTION

Chlorinated sucrose preparation is a challenging process due to the need of chlorination in selective less reactive positions in sucrose molecule in competition with more reactive positions. Generally, this objective is achieved by a procedure which involves either (a) essentially protecting the 6-hydroxy group in the pyranose ring of sugar molecule by using various protecting agents alkyl/aryl anhydride, acid chlorides, orthoesters etc., or (b) developing the desired sucrose acetate or benzoate or (C) by fermentation or enzymatic method, and the protected sucrose is then chlorinated in the desired positions (1-6 & 4) to give the acetyl derivative of the product, which is then deacylated to give the desired product TGS.

Alternatively, one may start the process of synthesis from using a derivative of sucrose at 6 position, such as sucrose-6-acetate or benzoate or analogous compound or analogues as starting material for production of TGS.

Strategies of prior art methods of production of TGS are based on following: Sucrose-6-acetate is chlorinated by Vilsmeier Haack reagent to form 6 acetyl 4,1′,6′trichlorogalactosucrose (TGS-6-acetate). After chlorination, the deacetylation of TGS-6-acetate to TGS is carried out in the reaction mixture itself. The TGS is then purified from the reaction mixture in various conventional ways of separation consisting of selective extraction into water immiscible solvent or solvents, crystallization, precipitation, drying, chromatographic separation and combinations thereof. Application of molecular separation methods was, however, never anticipated for various separation steps involved in the production process of TGS.

### SUMMARY OF INVENTION

An embodiment of this invention comprises application of a molecular separation process, including a membrane separation/filtration process comprising of one or more of a process of reverse osmosis, micro filtration, nanofiltration, ultrafiltration and perevaporation to a process stream for achieving a separation of molecules. This has led to simplification of the chemistry to be handled and development of a novel more efficient and convenient process/es for production, purification and isolation of TGS, TGS precursors and TGS derivatives.

Throughout this specification, unless the context doesn't permit or indicates to the contrary, a singular includes plural also e.g. “a molecular separation process” includes any one or more or all “molecular separation processes” also, “a membrane separation/filtration process” includes any one or more or all processes known in the art of “membrane separation/filtration processes”, “a process stream” for production, purification and isolation of TGS, TGS precursors and TGS derivatives includes any one or more or all “process streams” encountered in process steps of all known processes for production, purification and isolation of TGS, TGS precursors and TGS derivatives

Embodiments illustrative of this invention include, for example, application of one or more molecular separation processes including membrane separation process/es to achieve the objective of separating one or a group of the molecules from one or a group of the other molecules in process streams obtained in processes including enzymatic or non-enzymatic processes, of a sucrose chlorination process, before or after deacylation, and the like, comprising one or more of following:
a) Isolation and concentration of the organic sucrose derivatives free from DMF and/or inorganics from reaction mixtures including the chlorination reaction mixture;
b) Removal of inorganics from the solids obtained by drying the reaction mixture by various methods of drying including ATFD (Agitated Thin Film Dryer as described in Ratnam et. al. (2005) in patent application publication no. WO/2005/090374 and Ratnam et al. (2005) patent application publication no. WO/2005/090376), after dissolution in aqueous medium;
c) Concentration of product fractions obtained after purification from column chromatography or other purification methods;
d) Separation of glucose-6-acetate from sucrose-6-acetate in an enzymatic conversion process.

Many more embodiments of this invention can thus be conceived with respect to similar process streams from several prior art processes, enzymatic as well as non-enzymatic, of production of TGS, of production of precursors of TGS and of production of derivatives of TGS.

### DETAILED DESCRIPTION OF INVENTION

Several processes of production of TGS, enzymatic as well as non-enzymatic, have been described so far which also include derivatization of precursors of TGS or of TGS itself where a process is aimed at isolation and purification of one or more of its components from the reaction mixtures. Such processes include those described in, but without being restricted to, Fairclough, Hough and Richardson, Carbohydrate Research 40 (1975) 285-298, Mufti et al (1983) U.S. Pat. No. 4,380,476, Rathbone et al (1986) U.S. Pat. No. 4,380,476, O'Brien et al (1988) U.S. Pat. No. 4,783,526, Tully et al (1989) U.S. Pat. No. 4,801,700, Rathbone et al (1989) U.S. Pat. No. 4,826,962, Simpson (1989) U.S. Pat. No. 4,889,928, Navia (1990) U.S. Pat. No. 4,950,746, Horner et al (1990) U.S. Pat. No. 4,977,254, Walkup et al (1990) U.S. Pat. No. 4,980,463, Neiditch et al (1991) U.S. Pat. No. 5,023,329, Vernon et al (1991) U.S. Pat. No. 5,034,551, Walkup et al (1992) U.S. Pat. No. 5,089,608, Dordick et al (1992) U.S. Pat. No. 5,128,248, Khan et al (1992) U.S. Pat. No. 5,136,031, Bornemann et al (1992) U.S. Pat. No. 5,141,860, Dordick et al (1993) U.S. Pat. No. 5,270,460, Navia et al (1994) U.S. Pat. No. 5,298,611, Khan et al (1995) U.S. Pat. No. 5,440,026, Palmer et al (1995) U.S. Pat. No. 5,445,951, Sankey (1995) U.S. Pat. No. 5,449,772, Sankey et al (1995) U.S. Pat. No. 5,470,969, Navia et al (1996) U.S. Pat. No. 5,498,709, Navia et al (1996) U.S. Pat. No. 5,530,106, Catani et al (2003) US patent application publication no. 20030171574, Ratnam et al (2005) patent application publication WO/2005/090374, Ratnam et al (2005) WO/2005/090376 and the like.

Chlorination of sucrose-6-acetate is a key step in many of above mentioned processes, the process flow of which contains chlorinated sucrose-6-acetate, DMF, and inorganic as well as organic impurities. This reaction mass is neutralized to pH 7.0-7.5. Isolating chlorinated sucrose-6-acetate, or TGS and other chlorinated sucrose derivatives obtained after deacyalation, from this reaction mixture, particularly in presence of DMF is a challenging task. Prior art approach includes selective extraction of sucrose derivatives into an organic layer leaving behind the inorganic impurities formed during the chlorination reaction. The membrane molecular sieve technology for the purification and isolation of chlorinated sucrose derivatives can be carried out at various stages in the course of isolating the desired product by targeting removal of a specific molecular fraction or a group of molecular fractions before or after deacetylation. Some of the illustrative ways include, without limiting to:

a) Isolation and concentration of the sucrose derivatives, contained in the neutralized chlorination mass, free from DMF and/or inorganics;
b) Removal of inorganics contained in the solids obtained after drying the reaction mixture with various methods of drying, including ATFD drying, after dissolution of the said solids in aqueous medium;
c) Concentration of product fractions, comprising sucrose-6-esters, chlorinated sucrose-6-esters, TGS and other chlorinated sucroses and the like obtained after purification from column chromatography or other purification methods.

In the embodiment (a) the neutralized mass after chlorination is diluted to approximately 10% dissolved solids concentration using water. This solution is then filtered through an appropriate filter aid to make the solution free from any suspended impurities or solids. The solution is then subjected to membrane separation using a single or a series of a process of microfiltration, nanofiltration and Reverse Osmosis filtration systems. The rejections from the filtrations are recirculated in the feed tank. The permeate or the filtrate from the membrane system is collected separately. Most of the low molecular weight compounds along with DMF will pass through the membrane as permeate. As the level in the feed tank reduces, the DMF and the inorganics content are monitored. If higher amount of inorganics or DMF is still found in the feed, the feed can be diluted with excess water and the filtration continued. The process can be repeated until volume of the feed is reduced to 5-10% of the initial feed under which conditions DMF and inorganics content usually get reduced respectively to about 0.05-0.2% and 4-8%. The feed solution (rejection from the membrane) which contains TGS-6-acetate can then be subjected to extraction with ethyl acetate or other suitable solvents. The solvent(s) or ethyl acetate extract are then subjected to concentration to obtain syrup rich in desired product. The syrup was then subjected to column chromatography. The pure fractions were concentrated and then crystallized by suitable methods.

In embodiment (b), the neutralized mass from a chlorination reaction mixture can be subjected to drying by various methods including ATFD drying for the removal of water and DMF. The said solids collected are dissolved in 10 volumes of DM water. The solution is then filtered through appropriate filter aid to remove insoluble matter. The residual product remaining in the filter aid may be recovered by further dissolving and extracting the said target molecule. This filtrate can then be subjected to membrane separation system, which consists of a series of ultra/nanofiltration membranes and Reverse Osmosis membranes. The rejections from the membranes can be recirculated in the feed tank. The low molecular inorganic compounds start to permeate through the membranes. The feed is diluted with excess water during the filtration to allow maximum removal of low molecular inorganics through the membrane. The volume of the feed was then reduced to 10% of the initial feed and then the inorganic content was measured and was found to be 4.8%.

The solution (feed) was then extracted into suitable amount of ethyl acetate or other solvents. The extract was concentrated and subjected to column chromatography for further purification and crystallization.

In embodiment (c), the membrane system is also used for concentrating the pure product fractions obtained from the chromatographic column or from previous molecular separation techniques/process(es). The syrup containing the mixture of the chlorinated sucrose derivatives is loaded on to a hydrophobic silica column. Pure compounds eluted from the column in low strength aqueous buffer solutions. These fractions are collected separately and subjected to Reverse Osmosis.

In an enzymatic process, after the formation of the sucrose-6-acetate, its separation from the glucose-6-acetate is achieved using a nanofiltration membrane at 300-350 daltons molecular weight cut off. The glucose-6-acetate being a low molecular weight compound is collected as permeate with water and the sucrose-6-acetate is collected from the reject end.

The reverse osmosis membrane is the lowest pore size membrane which allows components of molecular weight less than 150 to 200 only. The membrane is made of composite polyamide material. Other solvent resistant membranes such as polyethersulphone can also be used. During the process of this filtration, the lower molecular weight compound which is predominantly water itself, pass out as permeate and the molecular species of higher molecular weight are retained and concentrated in the retaintate (retained fluid).

The examples given below and embodiments disclosed serve only to illustrate the manner of working of this invention without in any way limiting the scope of machines used, equipment used, reaction conditions, reactants, process steps to which molecular sieve methods and membrane separation processes are applicable; and methods which are analogous to the disclosures and their adaptations and modifications obvious to the people ordinarily skilled in the art are also covered within the scope of this specification.

### EXAMPLE 1

### Molecular Separation Methods Applied to Chlorination Reaction Mixture

252.8 g of PCl₅ was reacted with 3 L of DMF to form the Vilsmeier-Haack reagent and the in situ generated POCl₃ formed another vilsmeier with DMF. Then 600 g of sucrose-6-acetate solution in DMF was added dropwise below 0° C. and chlorination was carried out. The solution was then chlorinated at the 4, 1′ 6′ positions by maintaining the reaction mixture at elevated temperature conditions. The reaction mass was heated to 80° C. maintained for 60 minutes, further heated to 100° C. and maintained for 6 hours. Then the mass was again heated to 114° C. and maintained for 2.5 hours. After chlorination, the reaction mass was neutralized to pH 7.0-7.5 using calcium hydroxide slurry. The insoluble phosphate was filtered off through the filter press.

The filtrate (25 L) was now free from suspended solids and was taken for membrane filtration. This filtrate has 18-20% of DMF, 300 g of 6-acetyl TGS along with various other di chloro and tetrachloro derivatives as impurities. Along with the organic impurities, the solution contained calcium chlorides as inorganic impurities.

This filtrate was first passed through an ultrafiltration membrane to remove any finely dispersed solids at micron levels. Then it was passed through a nanofiltration membrane which had a molecular weight cut off ranging between 350-400 daltons. Here the compounds which had molecular weight below 350 daltons passed through as membrane permeate and the higher molecular weight compounds were collected as rejections. DMF and most of the inorganics get permeated in the low molecular weight fraction along with water. The higher molecular reject end consist of TGS-6-acetate and the tetra chloro impurities. The feed tank is diluted with 50 L of water and filtration through the membrane was continued to remove the trace inorganic compounds. This was repeated two more times and the inorganics and DMF was totally separated.

The DMF free process stream/reaction mixture of TGS-6-acetate with the tetrachloro derivatives as impurities was then passed through another set of nanofiltration membrane where the molecular weight cut off was 400 to 450 daltons. Here about 85% of the TGS-6-acetate passes through the membrane as permeate and about 15% is retained along with tetra chloro impurities.

The TGS-6-acetate from the permeate fraction is then concentrated by reverse osmosis membrane where the excess water is removed and the TGS-6-acetate is concentrated up to 35% w/v concentration in the retaintate. This solution is then deacetylated using sodium hydroxide solution at pH 9.0-9.5. The TGS formed is then extracted into 1:3.5 times v/v of ethyl acetate, concentrated, charcoalized and crystallized. The overall efficiency obtained through the process from chlorination stage was found to be 65%.

### EXAMPLE 2

### Molecular Separation Methods Applied to ATFD Dried Chlorination Reaction Mixture

31.5 g of PCl₅ was reacted with 60 kg of DMF to form the Vilsmeier-Haack reagent and the in-situ generated POCl₃ formed another Vilsmeier-Haack reagent with DMF. Then 10 kg of sucrose-6-acetate solution in DMF was added dropwise below 0° C. and chlorination was carried out. The solution was then chlorinated at the 4, 1′ 6′ positions by maintaining the reaction mixture at elevated temperature conditions as described in Example 1.

The reaction mass was then neutralized with calcium hydroxide and deacetylated at pH 9.0-9.5. The mass was then filtered through the filter press to remove the insoluble phosphates. 375 L of filtrate obtained was passed through the ATFD for DMF removal.

The ATFD solids obtained was dissolved in 5-6 times w/v of DM water and was passed through the ultrafiltration membrane to remove extraneous solids present and then taken for nanofiltration (300-350 molecular wt. Cut off) as described in example 1. Here the dichloro impurities and inorganic salts were separated in the permeate and the TGS and tetrachloro compounds were obtained in the reject end.

The TGS with tetrachloro compounds were diluted 3-4 times v/v with DM water and was passed through the second set of nanofiltration membranes. The TGS obtained in the permeate end was then concentrated in the Reverse Osmosis membrane up to 35% w/v concentration, extracted into 3.5 times v/v of ethyl acetate, concentrated, charcoalized and crystallized. The overall yield from chlorination stage was found to be 72%.

### EXAMPLE 3

### Molecular Separation Methods Applied to Concentration OF THE EFFLUENTS FRACTIONS OF COLUMN CHROMATOGRAPHY

31.5 g of PCl₅ was reacted with 60 kg of DMF to form the Vilsmeier-Haack reagent and the in situ generated POCl₃ formed another Vilsmeier-Haack reagent with DMF. Then 10 kg of sucrose-6-acetate solution in DMF was added dropwise below 0° C. and chlorination was carried out. The solution was then chlorinated at the 4, 1′ 6′ positions by maintaining the reaction mixture at elevated temperature conditions as described in experiment 1.

After chlorination, the reaction mass was neutralized to pH 7.0-7.5 using calcium hydroxide slurry. The insoluble phosphate was filtered off through the filter press. The filtrate was then passed through ATFD for the removal of DMF.

The solids (50 kg) obtained from ATFD were dissolved in 3-4 times of DM water and filtered to remove suspended solids. Then the solution was extracted into 3-4 times of ethyl acetate and concentrated. The concentrated syrup obtained was then loaded into 8-10 times of silanized silica gel packed in a chromatographic column. The chromatography was carried out using 0.05 molar sodium acetate solution in water. The pure aqueous fractions obtained were pooled together and were concentrated in the Reverse Osmosis membrane system up to 35% concentration, the flow in the permeate end was very poor. The Reverse Osmosis filtration was stopped, the 35% product suspension was deacetylated and extracted into 3.5 times of ethyl acetate. The ethyl acetate extract was concentrated, charcoalized and crystallized. The overall yield from chlorination stage was found to be 56%.

### TECHNICAL FIELD

The present invention relates to a process wherein molecular separation processes are used in various steps of process for production for synthesis of chlorinated sucrose, 1-6-Dichloro-1-6-DIDEOXY-β-Fructofuranasyl-4-chloro-4-deoxy-galactopyranoside (TGS), their precursors and derivatives.

### BACKGROUND OF THE INVENTION

Chlorinated sucrose preparation is a challenging process due to the need of chlorination in selective less reactive positions in sucrose molecule in competition with more reactive positions. Generally, this objective is achieved by a procedure which involves either (a) essentially protecting the 6-hydroxy group in the pyranose ring of sugar molecule by using various protecting agents alkyl/aryl anhydride, acid chlorides, orthoesters etc., or (b) developing the desired sucrose acetate or benzoate or (C) by fermentation or enzymatic method, and the protected sucrose is then chlorinated in the desired positions (1-6 & 4) to give the acetyl derivative of the product, which is then deacylated to give the desired product TGS.

Alternatively, one may start the process of synthesis from using a derivative of sucrose at 6 position, such as sucrose-6-acetate or benzoate or analogous compound or analogues as starting material for production of TGS.

Strategies of prior art methods of production of TGS are based on following: Sucrose-6-acetate is chlorinated by Vilsmeier Haack reagent to form 6 acetyl 4,1′,6′trichlorogalactosucrose (TGS-6-acetate). After chlorination, the deacetylation of TGS-6-acetate to TGS is carried out in the reaction mixture itself. The TGS is then purified from the reaction mixture in various conventional ways of separation consisting of selective extraction into water immiscible solvent or solvents, crystallization, precipitation, drying, chromatographic separation and combinations thereof. Application of molecular separation methods was, however, never anticipated for various separation steps involved in the production process of TGS.

### SUMMARY OF INVENTION

An embodiment of this invention comprises application of a molecular separation process, including a membrane separation/filtration process comprising of one or more of a process of reverse osmosis, micro filtration, nanofiltration, ultrafiltration and perevaporation to a process stream for achieving a separation of molecules. This has led to simplification of the chemistry to be handled and development of a novel more efficient and convenient process/es for production, purification and isolation of TGS, TGS precursors and TGS derivatives.

Throughout this specification, unless the context doesn't permit or indicates to the contrary, a singular includes plural also e.g. “a molecular separation process” includes any one or more or all “molecular separation processes” also, “a membrane separation/filtration process” includes any one or more or all processes known in the art of “membrane separation/filtration processes”, “a process stream” for production, purification and isolation of TGS, TGS precursors and TGS derivatives includes any one or more or all “process streams” encountered in process steps of all known processes for production, purification and isolation of TGS, TGS precursors and TGS derivatives

Embodiments illustrative of this invention include, for example, application of one or more molecular separation processes including membrane separation process/es to achieve the objective of separating one or a group of the molecules from one or a group of the other molecules in process streams obtained in processes including enzymatic or non-enzymatic processes, of a sucrose chlorination process, before or after deacylation, and the like, comprising one or more of following:
a) Isolation and concentration of the organic sucrose derivatives free from DMF and/or inorganics from reaction mixtures including the chlorination reaction mixture;
b) Removal of inorganics from the solids obtained by drying the reaction mixture by various methods of drying including ATFD (Agitated Thin Film Dryer as described in Ratnam et. al. (2005) in patent application publication no. WO/2005/090374 and Ratnam et al. (2005) patent application publication no. WO/2005/090376), after dissolution in aqueous medium;
c) Concentration of product fractions obtained after purification from column chromatography or other purification methods;
d) Separation of glucose-6-acetate from sucrose-6-acetate in an enzymatic conversion process.

Many more embodiments of this invention can thus be conceived with respect to similar process streams from several prior art processes, enzymatic as well as non-enzymatic, of production of TGS, of production of precursors of TGS and of production of derivatives of TGS.

### DETAILED DESCRIPTION OF INVENTION

Several processes of production of TGS, enzymatic as well as non-enzymatic, have been described so far which also include derivatization of precursors of TGS or of TGS itself where a process is aimed at isolation and purification of one or more of its components from the reaction mixtures. Such processes include those described in, but without being restricted to, Fairclough, Hough and Richardson, Carbohydrate Research 40 (1975) 285-298, Mufti et al (1983) U.S. Pat. No. 4,380,476, Rathbone et al (1986) U.S. Pat. No. 4,380,476, O'Brien et al (1988) U.S. Pat. No. 4,783,526, Tully et al (1989) U.S. Pat. No. 4,801,700, Rathbone et al (1989) U.S. Pat. No. 4,826,962, Simpson (1989) U.S. Pat. No. 4,889,928, Navia (1990) U.S. Pat. No. 4,950,746, Horner et al (1990) U.S. Pat. No. 4,977,254, Walkup et al (1990) U.S. Pat. No. 4,980,463, Neiditch et al (1991) U.S. Pat. No. 5,023,329, Vernon et al (1991) U.S. Pat. No. 5,034,551, Walkup et al (1992) U.S. Pat. No. 5,089,608, Dordick et al (1992) U.S. Pat. No. 5,128,248, Khan et al (1992) U.S. Pat. No. 5,136,031, Bornemann et al (1992) U.S. Pat. No. 5,141,860, Dordick et al (1993) U.S. Pat. No. 5,270,460, Navia et al (1994) U.S. Pat. No. 5,298,611, Khan et al (1995) U.S. Pat. No. 5,440,026, Palmer et al (1995) U.S. Pat. No. 5,445,951, Sankey (1995) U.S. Pat. No. 5,449,772, Sankey et al (1995) U.S. Pat. No. 5,470,969, Navia et al (1996) U.S. Pat. No. 5,498,709, Navia et al (1996) U.S. Pat. No. 5,530,106, Catani et al (2003) US patent application publication no. 20030171574, Ratnam et al (2005) patent application publication WO/2005/090374, Ratnam et al (2005) WO/2005/090376 and the like.

Chlorination of sucrose-6-acetate is a key step in many of above mentioned processes, the process flow of which contains chlorinated sucrose-6-acetate, DMF, and inorganic as well as organic impurities. This reaction mass is neutralized to pH 7.0-7.5. Isolating chlorinated sucrose-6-acetate, or TGS and other chlorinated sucrose derivatives obtained after deacyalation, from this reaction mixture, particularly in presence of DMF is a challenging task. Prior art approach includes selective extraction of sucrose derivatives into an organic layer leaving behind the inorganic impurities formed during the chlorination reaction. The membrane molecular sieve technology for the purification and isolation of chlorinated sucrose derivatives can be carried out at various stages in the course of isolating the desired product by targeting removal of a specific molecular fraction or a group of molecular fractions before or after deacetylation. Some of the illustrative ways include, without limiting to:

a) Isolation and concentration of the sucrose derivatives, contained in the neutralized chlorination mass, free from DMF and/or inorganics;
b) Removal of inorganics contained in the solids obtained after drying the reaction mixture with various methods of drying, including ATFD drying, after dissolution of the said solids in aqueous medium;
c) Concentration of product fractions, comprising sucrose-6-esters, chlorinated sucrose-6-esters, TGS and other chlorinated sucroses and the like obtained after purification from column chromatography or other purification methods.

In the embodiment (a) the neutralized mass after chlorination is diluted to approximately 10% dissolved solids concentration using water. This solution is then filtered through an appropriate filter aid to make the solution free from any suspended impurities or solids. The solution is then subjected to membrane separation using a single or a series of a process of microfiltration, nanofiltration and Reverse Osmosis filtration systems. The rejections from the filtrations are recirculated in the feed tank. The permeate or the filtrate from the membrane system is collected separately. Most of the low molecular weight compounds along with DMF will pass through the membrane as permeate. As the level in the feed tank reduces, the DMF and the inorganics content are monitored. If higher amount of inorganics or DMF is still found in the feed, the feed can be diluted with excess water and the filtration continued. The process can be repeated until volume of the feed is reduced to 5-10% of the initial feed under which conditions DMF and inorganics content usually get reduced respectively to about 0.05-0.2% and 4-8%. The feed solution (rejection from the membrane) which contains TGS-6-acetate can then be subjected to extraction with ethyl acetate or other suitable solvents. The solvent(s) or ethyl acetate extract are then subjected to concentration to obtain syrup rich in desired product. The syrup was then subjected to column chromatography. The pure fractions were concentrated and then crystallized by suitable methods.

In embodiment (b), the neutralized mass from a chlorination reaction mixture can be subjected to drying by various methods including ATFD drying for the removal of water and DMF. The said solids collected are dissolved in 10 volumes of DM water. The solution is then filtered through appropriate filter aid to remove insoluble matter. The residual product remaining in the filter aid may be recovered by further dissolving and extracting the said target molecule. This filtrate can then be subjected to membrane separation system, which consists of a series of ultra/nanofiltration membranes and Reverse Osmosis membranes. The rejections from the membranes can be recirculated in the feed tank. The low molecular inorganic compounds start to permeate through the membranes. The feed is diluted with excess water during the filtration to allow maximum removal of low molecular inorganics through the membrane. The volume of the feed was then reduced to 10% of the initial feed and then the inorganic content was measured and was found to be 4.8%.

The solution (feed) was then extracted into suitable amount of ethyl acetate or other solvents. The extract was concentrated and subjected to column chromatography for further purification and crystallization.

In embodiment (c), the membrane system is also used for concentrating the pure product fractions obtained from the chromatographic column or from previous molecular separation techniques/process(es). The syrup containing the mixture of the chlorinated sucrose derivatives is loaded on to a hydrophobic silica column. Pure compounds eluted from the column in low strength aqueous buffer solutions. These fractions are collected separately and subjected to Reverse Osmosis.

In an enzymatic process, after the formation of the sucrose-6-acetate, its separation from the glucose-6-acetate is achieved using a nanofiltration membrane at 300-350 daltons molecular weight cut off. The glucose-6-acetate being a low molecular weight compound is collected as permeate with water and the sucrose-6-acetate is collected from the reject end.

The reverse osmosis membrane is the lowest pore size membrane which allows components of molecular weight less than 150 to 200 only. The membrane is made of composite polyamide material. Other solvent resistant membranes such as polyethersulphone can also be used. During the process of this filtration, the lower molecular weight compound which is predominantly water itself, pass out as permeate and the molecular species of higher molecular weight are retained and concentrated in the retaintate (retained fluid).

The examples given below and embodiments disclosed serve only to illustrate the manner of working of this invention without in any way limiting the scope of machines used, equipment used, reaction conditions, reactants, process steps to which molecular sieve methods and membrane separation processes are applicable; and methods which are analogous to the disclosures and their adaptations and modifications obvious to the people ordinarily skilled in the art are also covered within the scope of this specification.

### EXAMPLE 1

### Molecular Separation Methods Applied to Chlorination Reaction Mixture

252.8 g of PCl₅ was reacted with 3 L of DMF to form the Vilsmeier-Haack reagent and the in situ generated POCl₃ formed another vilsmeier with DMF. Then 600 g of sucrose-6-acetate solution in DMF was added dropwise below 0° C. and chlorination was carried out. The solution was then chlorinated at the 4, 1′ 6′ positions by maintaining the reaction mixture at elevated temperature conditions. The reaction mass was heated to 80° C. maintained for 60 minutes, further heated to 100° C. and maintained for 6 hours. Then the mass was again heated to 114° C. and maintained for 2.5 hours. After chlorination, the reaction mass was neutralized to pH 7.0-7.5 using calcium hydroxide slurry. The insoluble phosphate was filtered off through the filter press.

The filtrate (25 L) was now free from suspended solids and was taken for membrane filtration. This filtrate has 18-20% of DMF, 300 g of 6-acetyl TGS along with various other di chloro and tetrachloro derivatives as impurities. Along with the organic impurities, the solution contained calcium chlorides as inorganic impurities.

This filtrate was first passed through an ultrafiltration membrane to remove any finely dispersed solids at micron levels. Then it was passed through a nanofiltration membrane which had a molecular weight cut off ranging between 350-400 daltons. Here the compounds which had molecular weight below 350 daltons passed through as membrane permeate and the higher molecular weight compounds were collected as rejections. DMF and most of the inorganics get permeated in the low molecular weight fraction along with water. The higher molecular reject end consist of TGS-6-acetate and the tetra chloro impurities. The feed tank is diluted with 50 L of water and filtration through the membrane was continued to remove the trace inorganic compounds. This was repeated two more times and the inorganics and DMF was totally separated.

The DMF free process stream/reaction mixture of TGS-6-acetate with the tetrachloro derivatives as impurities was then passed through another set of nanofiltration membrane where the molecular weight cut off was 400 to 450 daltons. Here about 85% of the TGS-6-acetate passes through the membrane as permeate and about 15% is retained along with tetra chloro impurities.

The TGS-6-acetate from the permeate fraction is then concentrated by reverse osmosis membrane where the excess water is removed and the TGS-6-acetate is concentrated up to 35% w/v concentration in the retaintate. This solution is then deacetylated using sodium hydroxide solution at pH 9.0-9.5. The TGS formed is then extracted into 1:3.5 times v/v of ethyl acetate, concentrated, charcoalized and crystallized. The overall efficiency obtained through the process from chlorination stage was found to be 65%.

### EXAMPLE 2

### Molecular Separation Methods Applied to ATFD Dried Chlorination Reaction Mixture

31.5 g of PCl₅ was reacted with 60 kg of DMF to form the Vilsmeier-Haack reagent and the in-situ generated POCl₃ formed another Vilsmeier-Haack reagent with DMF. Then 10 kg of sucrose-6-acetate solution in DMF was added dropwise below 0° C. and chlorination was carried out. The solution was then chlorinated at the 4, 1′ 6′ positions by maintaining the reaction mixture at elevated temperature conditions as described in Example 1.

The reaction mass was then neutralized with calcium hydroxide and deacetylated at pH 9.0-9.5. The mass was then filtered through the filter press to remove the insoluble phosphates. 375 L of filtrate obtained was passed through the ATFD for DMF removal.

The ATFD solids obtained was dissolved in 5-6 times w/v of DM water and was passed through the ultrafiltration membrane to remove extraneous solids present and then taken for nanofiltration (300-350 molecular wt. Cut off) as described in example 1. Here the dichloro impurities and inorganic salts were separated in the permeate and the TGS and tetrachloro compounds were obtained in the reject end.

The TGS with tetrachloro compounds were diluted 3-4 times v/v with DM water and was passed through the second set of nanofiltration membranes. The TGS obtained in the permeate end was then concentrated in the Reverse Osmosis membrane up to 35% w/v concentration, extracted into 3.5 times v/v of ethyl acetate, concentrated, charcoalized and crystallized. The overall yield from chlorination stage was found to be 72%.

### EXAMPLE 3

### Molecular Separation Methods Applied to Concentration Of the Effluents Fractions of Column Chromatography

31.5 g of PCl₅ was reacted with 60 kg of DMF to form the Vilsmeier-Haack reagent and the in situ generated POCl₃ formed another Vilsmeier-Haack reagent with DMF. Then 10 kg of sucrose-6-acetate solution in DMF was added dropwise below 0° C. and chlorination was carried out. The solution was then chlorinated at the 4, 1′ 6′ positions by maintaining the reaction mixture at elevated temperature conditions as described in experiment 1.

After chlorination, the reaction mass was neutralized to pH 7.0-7.5 using calcium hydroxide slurry. The insoluble phosphate was filtered off through the filter press. The filtrate was then passed through ATFD for the removal of DMF.

The solids (50 kg) obtained from ATFD were dissolved in 3-4 times of DM water and filtered to remove suspended solids. Then the solution was extracted into 3-4 times of ethyl acetate and concentrated. The concentrated syrup obtained was then loaded into 8-10 times of silanized silica gel packed in a chromatographic column. The chromatography was carried out using 0.05 molar sodium acetate solution in water. The pure aqueous fractions obtained were pooled together and were concentrated in the Reverse Osmosis membrane system up to 35% concentration, the flow in the permeate end was very poor. The Reverse Osmosis filtration was stopped, the 35% product suspension was deacetylated and extracted into 3.5 times of ethyl acetate. The ethyl acetate extract was concentrated, charcoalized and crystallized. The overall yield from chlorination stage was found to be 56%.

1. A process for liquid phase separation of chemical constituents of a reaction mixture which is a process stream produced during a process of synthesis of or purification of or isolation of 1-6-Dichloro-1-6-DIDEOXY-β-Fructofuranosyl-4-chloro-4-deoxy-galactopyranoside (TGS), or its precursor or its derivative, by using
a. a molecular separation process comprising membrane separation process further comprising one or more of processes of reverse osmosis, microfiltration, nanofiltration, ultrafiltration, perevaporation and the like, used singly or in series or in combination with each other in any sequence,
b. further optionally combined, in any sequence, with another separation process useful for separation of constituents comprising one or more of a process of filtration, centrifugation, precipitation, crystallization, solvent extraction, liquid-liquid partitioning, counter-current extraction, column chromatography, super-critical extraction distillation, evaporation, and the like, used in any combination in any sequence.

2. A process of claim 1 wherein
a. the said process stream comprising a composition, produced during the course of a process step of synthesis of or purification of TGS, its precursors or its derivatives, further comprising a solution, with or without water, of reactants or products one of which at least is one or more of a Glucose-6-ester further comprising Glucose-6-acetate and Glucose-6-benzoate, a Sucrose-6-ester further comprising Sucrose-6-acetate and Sucrose-6-benzoate, TGS, a TGS-6-ester further comprising TGS-6-acetate and TGS-6-benzoate, a Tetrachloro sucrose ester further comprising Tetrachloro-6-acetate and Tetrachloro-6-benzoate, Tetrachloro sucrose, a Dichloro sucrose ester further comprising Dichloro-6-acetate and Dichloro-6-benzoate, Dichloro sucrose, inorganic salts, suspended solids, Tertiary amide, soluble enzymes, immobilized enzymes, penta acetyl sucrose, sucrose alkyl 4,6-orthoacylate, sucrose 2,3,6,3′,4′-penta ester, Sucrose 6,4′-diester, 4′,6-sucrose diacetae, sucrose-6-acetate, 2,3,6,3′-sucrose tetraacetate, sucrose alkyl 4,6-orthoester, sucrose octaacylate, sucrose heptaacylate, sucrose hexa-acylate, sucrose alkyl 4,6-orthoester, sucrose 4-ester, TGS penta acylates further comprising TGS penta acetate, TGS penta propionate, TGS penta butyrate, TGS penta glutarate, TGS penta laureate; and the like;
b. the said precursor of TGS comprising one or more of glucose, sucrose, sucrose-6-ester further comprising sucrose-6-acetate and sucrose-6-benzoate, TGS-6-ester further comprising including TGS-6-acetate and TGS-6-benzoate, tetrachlororaffinose, penta acetyl sucrose, sucrose alkyl 4,6-orthoacylate, sucrose 2,3,6,3′,4′-penta ester, Sucrose 6,4′-diesters, 4′,6-di-O-acetylsucrose, sucrose-6-acetate, 2,3,6,3′-sucrose tetraacetate, sucrose alkyl 4,6-orthoester, sucrose octa-acylate, sucrose hepta-acylate, and sucrose hexa-acylate, sucrose alkyl 4,6-orthoester, sucrose 4-ester; and the like;
c. the said derivative of TGS comprising TGS penta acylates further comprising TGS penta acetate, TGS penta propionate, TGS penta butyrate, TGS penta glutarate, TGS penta laureate and the like.

3. A process of claim 1 wherein:
a. the said reverse osmosis comprises use of a solvent compatible membrane with a molecular weight cut off between 150-200 daltons, as applied to solutions or reaction mixtures for separation objectives including one or both of (i) concentrating TGS-6-acylate, (ii) concentrating TGS;
b. the said nanofiltration comprises a process of filtration applied by using membranes preferably of around 300-350 daltons cut off, to solutions or reaction mixtures for achieving molecular separation including one or more of (i) separation of glucose-6-ester, including glucose-6-acetate and glucose-6-butyrate from other constituents, (ii) to remove extraneous solids from aqueous solution of dried reaction mixtures, (iii) to filter off TGS compounds from other constituents, (iv) to filter off tetrachloro sugars from other constituents;
c. the said ultrafiltration comprises a process of filtration Sappliedto solutions or reaction mixtures, usually preceded by and used in conjunction with a microfiltration membrane of preferably around 0.2 microns cut off, by using membranes preferably of about 10000 daltons molecular weight cut off for achieving molecular separation of one or more of (i) separating inorganics from organic constituents in the aqueous solution of solid obtained by drying the chlorination reaction mixture, (ii) to remove finely dispersed solids at micron level from filter pressed neutralized chlorination reaction mass, (iii) to remove extraneous solid particles from the solution in water of the dried solids derived from the drying of chlorination reaction mixture after or before deacylation.
